(19) United States
(12) Patent Application Publication
(10) Pub. No.: US 2005/0186332 A1
(43) Pub. Date: Aug. 25, 2005

(54) Production method of suspension board with circuit

(75) Inventors: Yasuhito Funada, Osaka (JP); Hitoki Kanagawa, Osaka (JP)

Correspondence Address: DICKINSON WRIGHT PLLC, 1901 L. STREET NW, SUITE 800, WASHINGTON, DC, 20036, US

(73) Assignee: Nitto Denko Corporation, Osaka (JP)

(21) Appl. No.: 11/059,465

(22) Filed: Feb. 16, 2005

(30) Foreign Application Priority Data
Feb. 20, 2004 (JP) JP2004-043763

(51) Int. Cl. B05D 5/12

(52) U.S. Cl. 427/96.1

(57) ABSTRACT

In order to provide a new production method of a suspension board with circuit capable of preventing deterioration of the outward appearance and defects in products caused by a metal supporting layer, and further capable of forming an electroless nickel plating layer having an even thickness in a reliable manner, an insulating base layer is first formed on a supporting board, and a chromium thin film and a copper thin film are formed next sequentially on the surface of the supporting board exposed from the insulating base layer and on the entire surface of the insulating base layer. Subsequently, a plating resist is formed in a reversal pattern with respect to the wired circuit pattern on the surface of the copper thin film, and a conductor layer is formed on the surface of the copper thin film exposed from the plating resist by electrolytic plating. The plating resist is removed after an electroless nickel plating layer is formed on the conductor layer. Subsequently, the copper thin film and the chromium thin film are removed sequentially, and an insulating cover layer is formed next.

### BACKGROUND OF THE INVENTION

1. Field of the Invention

The present invention relates to a production method of a suspension board with circuit, and more particularly, to a production method of a suspension board with circuit for use in a hard disc drive.

2. Description of the Prior Art

A suspension board with circuit used for a hard disc drive is a wired circuit board in which wired circuit pattern for connecting between a magnetic head and a read/write board to which read/write signals to be read and written by the magnetic head are transmitted are integrally formed in the suspension board suspending the magnetic head. This suspension board with circuit can suspend the magnetic head mounted thereon to keep its good floating position, with a minute interval between the magnetic head and a magnetic disk being held against an airflow generated when the magnetic head and the magnetic disk run relative to each other. Due to this, the suspension board with circuit is becoming widely used.

The suspension board with circuit as described above is normally produced in the manner as described below, for example, with reference to FIG. 5.

That is, an insulating layer 22 made of a polyimide resin is formed on the surface of a stainless foil 21 in a specific pattern (Cf. FIG. 5(a)). Subsequently, a chromium thin film 23 and a copper thin film 24 are formed sequentially across the entire surface of the stainless foil 21 including the insulating layer 22 by sputtering (Cf. FIG. 5(b)). After a conductor layer 25 is formed in the form of a wired circuit pattern on the copper thin film 24 by electrolytic copper plating (Cf. FIG. 5(c)), the copper thin film 24 and the chromium thin film 23 are removed by etching (Cf. FIG. 5(d)).

A hard nickel thin film 26 is formed next on the surface of the conductor layer 25 by electroless nickel plating to cover and protect the surface of the conductor layer 25 (Cf. FIG. 5(e)). It should be noted that the hard nickel thin film 26 is formed inevitably on the surface of the stainless foil 21 as well due to plating potential.

After the conductor layer 25 is covered and protected with a cover layer 27 made of a polyimide resin except for terminal portions (not shown) (Cf. FIG. 5(f)), the hard nickel thin film 26 on the terminal portions (not shown) and on the surface of the stainless foil 21 is peeled (Cf. FIG. 5(g)). Subsequently, the terminal portions (not shown) are subject to electrolytic nickel plating and then to electrolytic gold plating to form terminals (not shown) (for example, Cf. Japanese Laid-open (Unexamined) Patent Publication No. Hei 10-265572).

Meanwhile, in order to achieve a fine-pitched wired circuit board, an additive process has been adopted recently to produce a suspension board with circuit as described above.

According to the additive process, in the method as described above, a plating resist is formed in a reversal pattern with respect to the wired circuit pattern on the copper thin film 24, and the conductor layer 25 is formed next by electrolytic copper plating in the form of the wired circuit pattern on the surface of the copper thin film 24 exposed from the plating resist, after which the plating resist is removed. The copper thin film 24 and the chromium thin film 23 are then removed by etching. Subsequently, the hard nickel thin film 26 is formed on the surface of the conductor layer 25 by electroless nickel plating to cover and protect the surface of the conductor layer 25.

In the method as described above, however, the hard nickel thin film 26 is formed inevitably on the surface of the stainless foil 21 in addition to the surface of the conductor layer 25 by electroless nickel plating. The surface of the stainless foil 21 is thus corroded by a solution of palladium chloride catalyst used in activation during electroless nickel plating, or palladium deposits on the surface.

When the surface of the stainless foil 21 is corroded, the outward appearance is deteriorated. When palladium deposits on the surface of the stainless foil 21, gold particles deposit on the surface of the stainless foil 21 by the local battery effect in the latter step of applying electrolytic gold plating to the terminal portions, which results in defects in products.

Also, according to the method as described above, the stainless foil 21 and the conductor layer 25 are electrically insulated by the insulating layer 22, and electroless nickel plating is performed while the surface of each is being exposed. This makes the plating potential unstable, which in turn makes the thickness of the hard nickel thin film 26 inhomogeneous, and further generates partially non-plated portions.

### SUMMARY OF THE INVENTION

It is an object of the present invention to provide a new production method of a suspension board with circuit capable of preventing deterioration of the outward appearance and defects in products caused by a metal supporting layer, and further capable of forming an electroless nickel plating layer having an even thickness in a reliable manner.

The present invention provides a production method of a suspension board with circuit, comprising: a step of forming an insulating layer on a metal supporting layer in such a manner that a surface of the metal supporting layer is partially exposed from the insulating layer; a step of forming a plating resist in a reversal pattern with respect to a wired circuit pattern on the metal supporting layer exposed from the insulating layer and on the insulating layer; and a step of forming a conductor layer in a form of the wired circuit pattern on the insulating layer where the plating resist is not formed, then forming an electroless nickel plating layer to cover the conductor layer, and thereafter removing the plating resist.

According to this method, the electroless nickel plating layer is formed only on the conductor layer while the plating resist is formed on the surface of the metal supporting layer, and the plating resist is removed later. Hence, because the metal supporting layer is covered with the plating resist when the electroless nickel plating layer is being formed, it is possible to prevent erosion on the surface of the metal supporting layer or deposition of palladium on the surface induced by electroless nickel plating. It is thus possible to prevent deterioration of the outward appearance and defects in products caused by the metal supporting layer. In addition, according to this method, the conductor layer can be formed in the form of a fine-pitched wired circuit pattern easily in a reliable manner by the additive process.

The present invention also provides a new production method of a suspension board with circuit, comprising: a step of forming an insulating layer on a metal supporting layer in such a manner that a surface of the metal supporting layer is partially exposed from the insulating layer; a step of forming a metal thin film layer on the surface of the metal supporting layer exposed from the insulating layer and on a surface of the insulating layer; a step of forming a plating resist in a reversal pattern with respect to a wired circuit pattern on a surface of the metal thin film layer; a step of forming a conductor layer in a form of the wired circuit pattern on the surface of the metal thin film layer exposed from the plating resist, then forming an electroless nickel plating layer to cover the conductor layer, and thereafter removing the plating resist; and a step of removing the metal thin film layer.

According to this method, the electroless nickel plating layer is formed only on the conductor layer while the plating resist is formed on the surface of the metal supporting layer, and the plating resist is removed later. Hence, because the metal supporting layer is covered with the plating resist when the electroless nickel plating layer is being formed, it is possible to prevent erosion on the surface of the metal supporting layer or deposition of palladium on the surface induced by electroless nickel plating. It is thus possible to prevent deterioration of the outward appearance and defects in products caused by the metal supporting layer. In addition, according to this method, because electroless nickel plating is performed while the metal thin film layer and the conductor layer are electrically conducting, plating potential is allowed to remain stable, which in turn enables an electroless nickel plating layer having an even thickness to be formed only on the conductor layer in a reliable manner. Further, according to this method, the conductor layer can be formed in the form of a fine-pitched wired circuit pattern easily in a reliable manner by the additive process.

### BRIEF DESCRIPTION OF THE DRAWINGS

In the drawings:

FIG. 1 is a perspective view showing one embodiment of a suspension board with circuit produced by a production method of a suspension board with circuit of the present invention.

FIG. 2 illustrates the production process according to one embodiment of the production method of the suspension board with circuit shown in FIG. 1:

(a) shows the step of preparing a supporting board;

(b) shows the step of forming a coating of precursor of a photosensitive polyimide resin on the entire surface of the supporting board;

(c) shows the step of exposing to light the coating through a photomask;

(d) shows the step of developing the coating;

(e) shows the step of curing the coating and thereby forming an insulating base layer in a specific pattern;

(f) shows the step of forming a chromium thin film on the surface of the supporting board exposed from the insulating base layer and on the entire surface of the insulating base layer; and

(g) shows the step of forming a copper thin film on the entire surface of the chromium thin film.

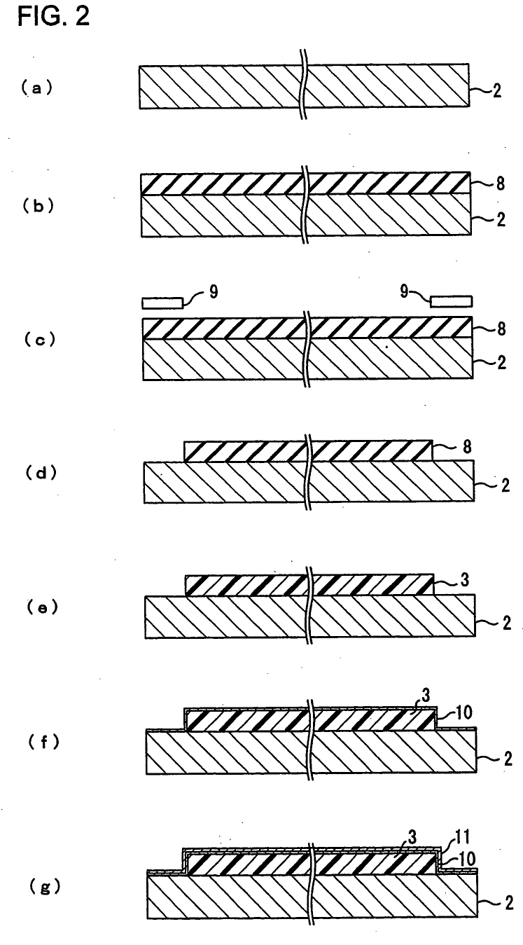

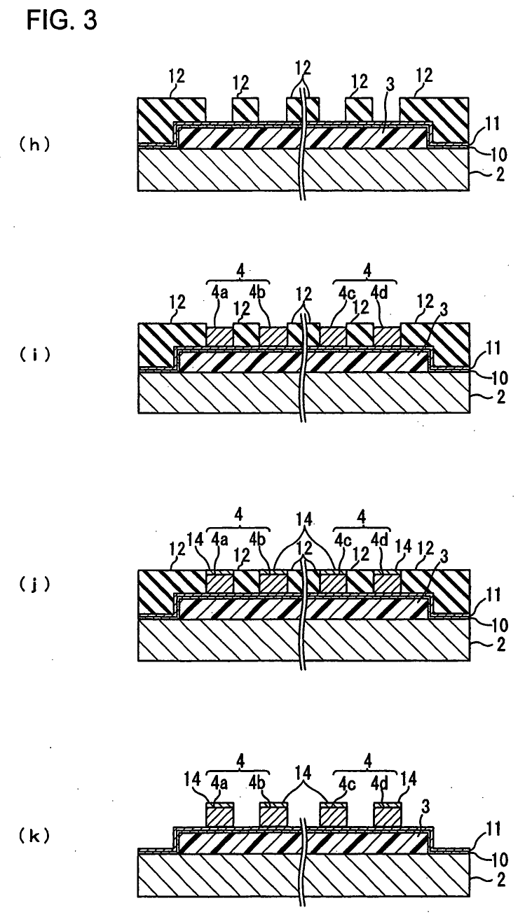

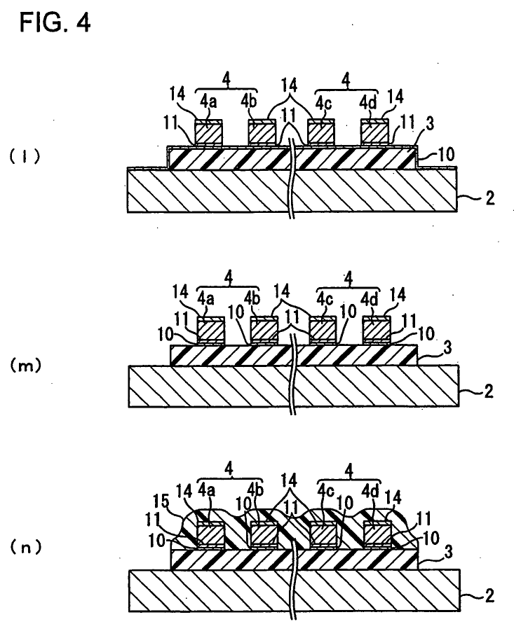

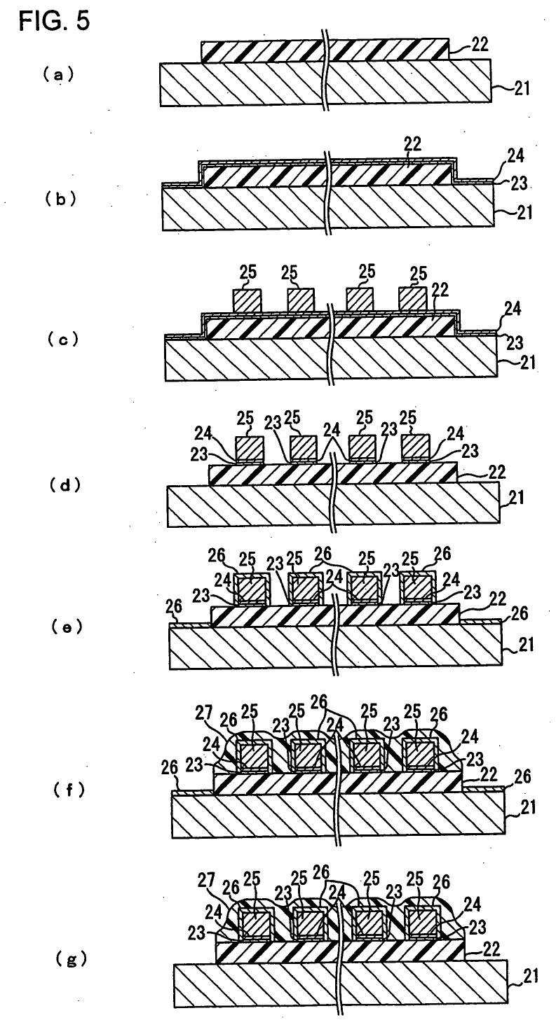

FIG. 3 illustrates the production process, continuing from FIG. 2, according to one embodiment of the production method of the suspension board with circuit:

(h) shows the step of forming a plating resist in a reversal pattern with respect to the wired circuit pattern on the surface of the copper thin film;

(i) shows the step of forming a conductor layer on the surface of the copper thin film exposed from the plating resist;

(j) shows the step of forming an electroless nickel plating layer on the surface of the conductor layer exposed from the plating resist; and

(k) shows the step of removing the plating resist.

FIG. 4 illustrates the production process, continuing from FIG. 3, according to one embodiment of the production method of the suspension board with circuit:

(l) shows the step of removing the copper thin film except for portions where the conductor layer is formed;

(m) shows the step of removing the chromium thin film except for portions where the conductor layer is formed; and

(n) shows the step of forming an insulating cover layer in a specific pattern to cover the conductor layer.

FIG. 5 illustrates the production process according to one embodiment of a production method of a suspension board with circuit in the prior art:

(a) shows the step of forming an insulating layer in a specific pattern on the surface of a stainless foil;

(b) shows the step of forming a chromium thin film and a copper thin film sequentially on the entire surface of the stainless foil including the insulating layer by sputtering;

(c) shows the step of forming a conductor layer in the form of the wired circuit pattern on the copper thin film by electrolytic copper plating;

(d) shows the step of removing the copper thin film and the chromium thin film by etching;

(e) shows the step of forming a hard nickel thin film on the surface of the conductor layer and on the surface of the stainless foil by electroless nickel plating;

(f) shows the step of covering and protecting the conductor layer with a cover layer; and

(g) shows the step of peeling the hard nickel thin film on the surface of the stainless foil.

### DETAILED DESCRIPTION OF THE PREFERRED EMBODIMENTS

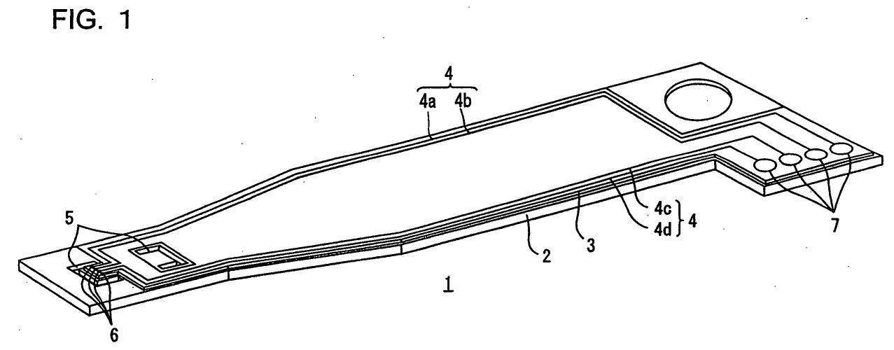

FIG. 1 is a perspective view showing one embodiment of a suspension board with circuit produced by a production method of a suspension board with circuit of the present invention.

Referring to FIG. 1, a suspension board with circuit 1 has a magnetic head (not shown) of a hard disc drive mounted thereon, and is configured to suspend the magnetic head while keeping a minute interval from the magnetic disc against airflow induced when the magnetic head and the magnetic disc run relatively to each other. Also, it is provided with an integrally formed wired circuit pattern to connect the magnetic head and a read/write board.

In the suspension board with circuit 1, an insulating base layer 3 served as an insulating layer is formed on a supporting board 2 extending in the longitudinal direction and served as a metal supporting layer, and a conductor layer 4 is formed on the insulating base layer 3 in the form of a wired circuit pattern. The wired circuit pattern is provided in the form of plural lines of wire 4a, 4b, 4c, and 4d arrayed in parallel with each other and spaced at specific intervals.

Gimbals 5 for being mounted the magnetic head therein are formed in the supporting board 2 by cutting out the front end portion of the supporting board 2. At the front end portion of the supporting board 2, magnetic head connecting terminals 6 are formed to connect the magnetic head and the respective lines of wire 4a, 4b, 4c, and 4d.

Also, at the rear end portion of the supporting board 2, external-side connecting terminals 7 are formed to connect the read/write board and the respective lines of wire 4a, 4b, 4c, and 4d.

Although it is not shown in FIG. 1, in practice, the conductor layer 4 is covered with an insulating cover layer 15 (Cf. FIG. 4(n)).

One embodiment of the production method of a suspension board with circuit of the present invention will now be described with reference to FIG. 2 through FIG. 4, using, by way of example, the production method of the suspension board with circuit 1 shown in FIG. 1. FIG. 2 through FIG. 4 show the cross section of the suspension board with circuit 1 somewhere in the middle in the longitudinal direction, along the width direction orthogonal to the longitudinal direction of the suspension board with circuit 1.

According to this method, as is shown in FIG. 2(a), the supporting board 2 is prepared first. It is preferable to use a metal foil or a metal thin plate as the supporting board 2, and metals, such as stainless, 42 alloy, aluminum, copper-beryllium, and phosphor bronze, are used preferably. A thickness thereof is preferably in the range of 10-60 μm, or more preferably 15-30 μm, and a width thereof is preferably in the range of 50-500 mm, or more preferably 125-300 mm.

According to this method, the insulating base layer 3 is formed next on the supporting board 2 in a specific pattern so that the surface of the supporting board 2 to be exposed partially.

No particular limitation is imposed on insulators used to form the insulating base layer 3 as long as they can be used as insulators for a suspension board with circuit. Examples of such insulators include synthetic resins, such as a polyimide resin, a polyamide-imide resin, an acrylic resin, a polyether nitrile resin, a polyether sulfonic resin, a polyethylene terephthalate resin, a polyethylene naphthalate resin, and a polyvinyl chloride resin. Of these resins, a photosensitive synthetic resin is used preferably, and a photosensitive polyimide resin is used more preferably.

In a case where the insulating base layer 3 is formed, for example, from the photosensitive polyimide resin in a specific pattern on the supporting board 2, as is shown in FIG. 2(b), a solution of precursor of the photosensitive polyimide resin (polyamic acid resin) is applied on the entire surface of the supporting board 2, followed by heating at a temperature in the range of e.g. 60-150° C., or preferably 80-120° C. A coating 8 of the precursor of the photosensitive polyimide resin is thus formed.

Then, as is shown FIG. 2(c), the coating 8 is exposed to light through a photomask 9 and the exposed portion is heated to a predetermined temperature when necessary. The coating 8 is then developed, and, as is shown in FIG. 2(d), made in a specific pattern for part of the surface of the supporting board 2 (for example, the both end portions of the surface of the supporting board 2 in the width direction) to be exposed. For radiation irradiated through the photomask 9, an exposing wavelength is preferably in the range of 300-450 nm, or more preferably 350-420 nm, and an integrated quantity of exposure light is preferably in the range of 100-2000 mJ/cm².

When the exposed portion of the coating 8 thus irradiated is heated, for example, at a temperature in the range of not less than 130° C. to less than 150° C., it is solubilized (positive type) for the following development processing, and when heated, for example, at a temperature in the range of not less than 150° C. to not more than 200° C., it is non-solubilized (negative type) for the following development processing.

Development can be performed by a known method, such as a dipping process and a spraying process, with the use of a known developer, such as an alkaline developer. Preferably, this method uses the negative type to produce the specific pattern, and FIG. 2 shows an embodiment using the process steps of negative type for patterning the coating 8.

As is shown in FIG. 2(e), the coating 8 of the precursor of the photosensitive polyimide resin thus made in the specific pattern is finally heated to 250° C. or above to be cured (imidized). The insulating base layer 3 made of a polyimide resin is thus formed in a specific pattern for part of the surface of the supporting board 2 (for example, the both end portions of the surface of the supporting board 2 in the width direction) to be exposed.

In a case where a photosensitive synthetic resin is not used, for example, a synthetic resin is applied on the supporting board 2 in a specific pattern, or a dry film that has been made previously in a specific pattern is laminated thereon through an adhesive layer as occasion demands.

A thickness of the insulating base layer 3 formed in this manner is in the range of e.g. 2-30 μm, or preferably 5-25 μm.

According to this method, as are shown in FIGS. 2(f) and (g), a chromium thin film 10 and a copper thin film 11, both served as a metal thin film layer, are formed next sequentially on the surface of the supporting board 2 exposed from the insulating base layer 3 and on the entire surface of the insulating base layer 3.

A vacuum deposition method, in particular, a sputter deposition method, is used preferably to form the chromium thin film 10 and the copper thin film 11. To be more specific, as is shown in FIG. 2 (f), the chromium thin film 10 is first formed on the surface of the supporting board 2 exposed from the insulating base layer 3 and on the entire surface of the insulating base layer 3 by the sputter deposition method. Subsequently, as is shown in FIG. 2(g), the copper thin film 11 is formed on the entire surface of the chromium thin film 10 by the sputter deposition method.

A thickness of the chromium thin film 10 is preferably in the range of 100-600 Å, and a thickness of the copper thin film 11 is preferably in the range of 500-2000 Å.

According to this method, as is shown in FIG. 3(h), a plating resist 12 is formed next in a reversal pattern with respect to the wired circuit pattern on the surface of the copper thin film 11. To be more specific, the plating resist 12 is formed above the insulating base layer 3 and on the copper thin film 11 so that groove-shaped openings from which the copper thin film 11 is exposed are formed at portions corresponding to the plural lines of wire 4a, 4b, 4c, and 4d to be formed, and is also formed above the supporting board 2 at portions exposed through the insulating base layer 3 and on the surface of the copper thin film 11.

The plating resist 12 is formed in the form of a reversal pattern with respect to the wired circuit pattern described above by a known method, for example, with the use of a dry film resist. A thickness of the plating resist 12 is equal to or larger than a sum of the thicknesses of the conductor layer 4 and an electroless nickel plating layer 14 described below.

According to this method, as is shown in FIG. 3(i), the conductor layer 4 is formed next on the surface of the copper thin film 11 exposed from the openings in the plating resist 12. No particular limitation is imposed on conductors used to form the conductor layer 4 as long as they can be used as conductors for a suspension board with circuit. Examples of such conductors include copper, nickel, gold, solder, or alloys of the foregoing, and copper is used preferably.

No particular limitation is imposed on the formation of the conductor layer 4, and for example, electrolytic plating, preferably, electrolytic copper plating, is used. In the case of electrolytic plating, the conductor layer 4 is grown using the copper thin film 11 as a seed layer. As is shown in FIG. 3(i), the conductor layer 4 is grown in such a manner that the surface of the conductor layer 4 is positioned below the surface of the plating resist 12, so that the openings in the plating resist 12 are not fully filled with the conductor layer 4, that is to say, the electroless nickel plating layer 14 can be formed within the openings in the plating resist 12 in the following step.

By forming the conductor layer 4 on the surface of the copper thin film 11 exposed from the openings in the plating resist 12 by the additive process as has been described, it is possible to form the conductor layer 4 in the form of a fine-pitched wired circuit pattern easily in a reliable manner.

The wired circuit pattern is provided, for example, as is shown in FIG. 1, in the form of a pattern comprising plural lines of wire 4a, 4b, 4c, and 4d arrayed in parallel with each other and spaced at specific intervals. A thickness of the conductor layer 4 is in the range of e.g. 2-50 μm, or preferably 5-30 μm. A width of the respective lines of wire 4a, 4b, 4c, and 4d is in the range of e.g. 5-500 μm, or preferably 10-200 μm. An interval among the respective lines of wire 4a, 4b, 4c, and 4d is in the range of e.g. 5-500 μm, or preferably 10-200 μm.

According to this method, as is shown in FIG. 3(j), the electroless nickel plating layer 14 is formed next by electroless nickel plating to cover the surface of the conductor layer 4 exposed from the openings in the plating resist 12 while the plating resist 12 is left intact.

The electroless nickel plating layer 14 is formed, for example, in the following manner. That is, after the surface of the conductor layer 4 is activated with a solution of palladium chloride catalyst, it is dipped in an electroless nickel plating solution for electroless nickel plating to take place. The electroless nickel plating layer 14 is thus formed on the surface (top surface) of the conductor layer 4. The electroless nickel plating layer 14 is formed as a hard nickel thin film, and a thickness to prevent the surface of the conductor layer 4 from being exposed is sufficient, which is in the range of e.g. 0.05-0.2 μm.

The plating resist 12 is then removed as is shown in FIG. 3(k). The plating resist 12 is removed, for example, by a known method, such as chemical etching (wet etching), or it is simply peeled.

Subsequently, as is shown in FIG. 4(l), the copper thin film 11 is removed except for portions where the conductor layer 4 is formed. The copper thin film 11 is removed, for example, by chemical etching (wet etching), with the use of a mixed solution of nitric acid and hydrogen peroxide as an etchant.

According to this method, as is shown in FIG. 4 (m), the chromium thin film 10 is removed next except for portions where the conductor layer 4 is formed. The chromium thin film 10 is removed, for example, by chemical etching (wet etching) with the use of a potassium ferricyanide solution, a potassium permanganate solution, a sodium metasilicate solution or the like as an etchant.

Subsequently, according to this method, as is shown in FIG. 4(n), the insulating cover layer 15 to cover the conductor layer 4 is formed in a specific pattern. The same inslator used for the insulating base layer 3 is used as an insulator used to form the insulating cover layer 15, and a photosensitive polyimide resin is used preferably.

In a case where the insulating cover layer 15 is formed from the photosensitive polyimide resin, as with the insulating base layer 3, a solution of precursor of the photosensitive polyimide resin (polyamic acid resin) is applied on the insulating base layer 3 and on the electroless nickel plating layer 14 followed by heating. A coating of the precursor of the photosensitive polyimide resin is thus formed. The coating is then exposed through a photomask, and the exposed portion is heated to a predetermined temperature when necessary. The coating is then developed and made in a specific pattern. Subsequently, the coating is finally heated to 250° C. or above to be cured (imidized). The insulating cover layer 15 made of a polyimide resin is thus formed on the insulating base layer 3 that includes the conductor layer 4 whose top surface is covered with the electroless nickel plating layer 14. A thickness of the insulating cover layer 15 is in the range of 1-30 μm, or preferably 2-20 μm.

When the insulating cover layer 15 is formed, although it is not shown in drawing, the insulating cover layer 15 is formed in a specific pattern from which terminal portions to form both the magnetic head connecting terminals 6 and the external-side connecting terminals 7 and lead portions used in electrolytic plating are exposed. Then, the electroless nickel plating layer 14 in the respective terminal portions is peeled, after which a nickel plating layer and a gold plating layer are formed sequentially on the thus-exposed surface of the conductor layer 4 by electrolytic plating. The magnetic head connecting terminals 6 and the external-side connecting terminals 7 are thus formed.

The nickel plating layer and the gold plating layer are formed, for example, in the following manner. That is, the nickel plating layer is first formed on the exposed surface of the conductor layer 4 by electrolytic nickel plating, and the gold plating layer is formed next on the nickel plating layer by electrolytic gold plating. A thickness of each of the nickel plating layer and the gold plating layer is preferably in the range of 0.2-5 μm.

Subsequently, the unillustrated lead portions are removed by chemical etching or the like, and the supporting board 2 is cut out in a specific shape conforming to the gimbals 5 or the like by a known method, such as chemical etching, followed by rising and drying. The suspension board with circuit 1 as is shown in FIG. 1 is thus obtained.

According to the method as has been described, the electroless nickel plating layer 14 is formed only on the surface of the conductor layer 4 exposed from the openings in the plating resist 12 while the plating resist 12 is formed on the surface of the supporting board 2, and the plating resist 12 is removed later. Hence, when the electroless nickel plating layer 14 is being formed, the supporting board 2 is covered with the plating resist 12. This can prevent corrosion on the surface of the supporting board 2 or deposition of palladium on the surface induced by electroless nickel plating. It is thus possible to prevent deterioration of the outward appearance and defects in products caused by the supporting board 2. In addition, according to this method, electroless nickel plating is performed while the chromium thin film 10 and the copper thin film 11 are electrically conducting with the conductor layer 4. This allows plating potential to remain stable, which in turn enables the electroless nickel plating layer 14 having an even thickness to be formed only on the surface of the conductor layer 4 in a reliable manner.

The production method of the suspension board with circuit 1 as has been described can be achieved industrially by a known method, such as a roll-to-roll process.

### EXAMPLE

The invention will now be described more concretely in an example described below. It should be appreciated, however, that the invention is not particularly limited to the example below.

A stainless (SUS304) foil having a thickness of 25 μm was prepared (Cf. FIG. 2(a)).

Meanwhile, a solution of precursor of a photosensitive polyimide resin was prepared in the following manner. That is, 0.702 kg (6.5 moles) of p-phenylene diamine, 1.624 kg (5.5 moles) of 3,4,3′,4′-biphenyltetracarboxylic dianhydride (diphthalic dianhydride), and 0.444 kg (1.0 mole) of 2,2-bis(3,4-dicarboxy-phenyl)hexafluoropropane (6FDA) (a total of acid anhydrides: 6.5 kg) were dissolved in 19.72 kg of dimethyl acetamide, and kept stirred for 72 hours at room temperature.

Subsequently, the resulting solution was heated to 75° C., and the heating was stopped when the viscosity reached 5000 centipoises (5 Pa·s). The solution was then let stand until it was cooled to room temperature. Then, 0.9633 kg (2.78 moles) of nifedipine, 0.6422 kg (2.04 moles) of 4-o-nitrophenyl-3,5-diacetyl-1,4-dihydropyridine, and 0.161 kg (2.36 moles) of imidazole were added to the resulting solution. A solution of the precursor of the photosensitive polyimide resin was thus obtained.

The solution of the precursor of the photosensitive polyimide resin thus obtained was applied on the stainless foil described above, which was heated and dried for at 120° C. 2 minutes to form a coating of the precursor of the photosensitive polyimide resin (Cf. FIG. 2(b)). The coating was then exposed to UV rays (a quantity of exposure: 700 mJ/cm²) through a photomask (Cf. FIG. 2(c)). After the exposed portion was heated for at 160° C. 3 minutes, the coating was developed with the use of an alkaline developer. The coating was thus made into a specific pattern for the both end portions of the surface of the stainless foil in the width direction to be exposed, with the use of a negative type imaging (Cf. FIG. 2(d)).

The coating of the precursor of the photosensitive polyimide resin was heated at 400° C. in vacuum at 0.01 Torr (1.33 Pa) to be cured (imidized). An insulating base layer made of a polyimide resin and having a thickness of 6 μm was thus formed in a specific pattern for the both end portions of the surface of the stainless foil in the width direction to be exposed (Cf. FIG. 2(e)).

A chromium thin film having a thickness of 500 Å and a copper thin film having a thickness of 1000 Å were formed next sequentially on the surface of the stainless foil exposed from the insulating base layer and on the entire surface of the insulating base layer by the sputter deposition method (Cf. FIGS. 2(f) and (g)).

Subsequently, a plating resist in a reversal pattern with respect to the wired circuit pattern was formed on the surface of the copper thin film with the use of a dry film resist (Cf. FIG. 3(h)), and a conductor layer was formed in the form of the wired circuit pattern on the surface of the copper thin film exposed from the plating resist by electrolytic copper plating (Cf. FIG. 3(i)). The thickness of the conductor layer was 10 μm. Subsequently, an electroless nickel plating layer having a thickness of 0.5 μm was formed on the surface of the conductor layer exposed from the plating resist by electroless nickel plating while the plating resist was left intact (Cf. FIG. 3(j)).

After the plating resist was removed by chemical etching (Cf. FIG. 3(k)), the copper thin film was removed by chemical etching (wet etching) with the use of a mixed solution of nitric acid and hydrogen peroxide except for portions where the conductor layer was formed (Cf. FIG. 4(l)). Further, the chromium thin film was removed by chemical etching (wet etching) with the use of a mixed solution of potassium ferricyanide and potassium hydroxide except for portions where the conductor layer was formed (Cf. FIG. 4(m)).

A coating of precursor of the photosensitive polyimide resin was formed by applying the same solution of the precursor of the photosensitive polyimide resin used when forming the insulating base layer onto the insulating base layer and the electroless nickel plating layer, followed by heating as with the case of forming the insulating base layer. The coating was then exposed and developed, and the coating was thereby made into a specific pattern covering the conductor layer.

Then, as with the case of forming the insulating base layer, the coating of the precursor of the photosensitive polyimide resin was heated to be cured (imidized) in forming an insulating cover layer made of a polyimide resin (Cf. FIG. 4(n)). A suspension board with circuit was thus obtained.

The stainless foil in the suspension board with circuit thus obtained was observed, and the absence of corrosion and deposition of palladium was confirmed.

While illustrative embodiments of the invention are provided in the above description, such is for illustrative purpose only and is not to be construed restrictively. Modification and variation of the invention that will be obvious to those skilled in the art is to be covered by the following claims.

The disclosure of Japanese patent application Serial No. 2004-043763, filed on Feb. 20, 2004, is incorporated herein by reference.

1. A production method of a suspension board with circuit, comprising:
a step of forming an insulating layer on a metal supporting layer in such a manner that a surface of the metal supporting layer is partially exposed from the insulating layer;
a step of forming a plating resist in a reversal pattern with respect to a wired circuit pattern on the metal supporting layer exposed from the insulating layer and on the insulating layer; and
a step of forming a conductor layer in a form of the wired circuit pattern on the insulating layer where the plating resist is not formed, then forming an electroless nickel plating layer to cover the conductor layer, and thereafter removing the plating resist.

2. A production method of a suspension board with circuit, comprising:
a step of forming an insulating layer on a metal supporting layer in such a manner that a surface of the metal supporting layer is partially exposed from the insulating layer;
a step of forming a metal thin film layer on the surface of the metal supporting layer exposed from the insulating layer and on a surface of the insulating layer;
a step of forming a plating resist in a reversal pattern with respect to a wired circuit pattern on a surface of the metal thin film layer;
a step of forming a conductor layer in a form of the wired circuit pattern on the surface of the metal thin film layer exposed from the plating resist, then forming an electroless nickel plating layer to cover the conductor layer, and thereafter removing the plating resist; and
a step of removing the metal thin film layer.
